(19) United States
(12) Patent Application Publication
(10) Pub. No.: US 2019/0308630 A1
(43) Pub. Date: Oct. 10, 2019

(54) BATTERY STATE ESTIMATION BASED ON OPEN CIRCUIT VOLTAGE AND CALIBRATED DATA

(71) Applicant: GM GLOBAL TECHNOLOGY OPERATIONS LLC, Detroit, MI (US)

(72) Inventors: Raghunathan K, Troy, MI (US); Ramona Y. Ying, Rochester Hills, MI (US); Brian J. Koch, Berkley, MI (US); Charles W. Wampler, II, Birmingham, MI (US)

(21) Appl. No.: 15/949,827

(22) Filed: Apr. 10, 2018

(51) Int. Cl. B60W 40/12; B60W 10/06; B60W 20/13; B60W 50/14

(52) U.S. Cl. CPC B60W 40/12; B60W 10/06; B60W 20/13; B60W 2050/0026; B60W 2050/146; B60W 2510/244; B60W 2510/08; B60W 50/14

(57) ABSTRACT

A discharge module is configured to determine a change in capacity of the battery between: (i) a measurement of a first open circuit voltage (OCV) of a battery of a vehicle; and (ii) a measurement of a second OCV of the battery. A lookup table is stored in memory and includes reference states of charge (SOCs) indexed by reference OCVs and reference capacities. A relationship module is configured to: from the lookup table, identify a first set of the reference SOCs associated with the first OCV and the reference capacities, respectively; from the lookup table, identify a second set of the reference SOCs associated with the second OCV and the reference capacities, respectively; determine changes in SOC associated with the reference capacities; determine changes in capacity; and determine an equation that relates changes in capacity to capacity based on the changes in capacity and the reference capacities, respectively.

### INTRODUCTION

The present disclosure relates to vehicle propulsion systems and more particularly to systems and methods determining a state of charge of a battery of a vehicle.

This section provides background information related to the present disclosure which is not necessarily prior art.

Some types of vehicles include only an internal combustion engine that generates propulsion torque. Hybrid vehicles include both an internal combustion engine and one or more electric motors. Some types of hybrid vehicles utilize the electric motor and the internal combustion engine in an effort to achieve greater fuel efficiency than if only the internal combustion engine was used. Some types of hybrid vehicles utilize the electric motor and the internal combustion engine to achieve greater torque output than the internal combustion could achieve by itself.

Some example types of hybrid vehicles include parallel hybrid vehicles, series hybrid vehicles, and other types of hybrid vehicles. In a parallel hybrid vehicle, the electric motor works in parallel with the engine to combine power and range advantages of the engine with efficiency and regenerative braking advantages of electric motors. In a series hybrid vehicle, the engine drives a generator to produce electricity for the electric motor, and the electric motor drives a transmission. This allows the electric motor to assume some of the power responsibilities of the engine, which may permit the use of a smaller and possibly more efficient engine.

### SUMMARY

This section provides a general summary of the disclosure, and is not a comprehensive disclosure of its full scope or all of its features.

In a feature, a battery system of a vehicle includes a first storage module configured to selectively store a first open circuit voltage (OCV) of a battery of the vehicle. A second storage module is configured to selectively store a second OCV of the battery of the vehicle. A discharge module is configured to determine a change in capacity of the battery between: (i) the measurement of the first OCV of the battery; and (ii) the measurement of the second OCV of the battery. A lookup table is stored in memory and includes reference states of charge (SOCs) indexed by reference OCVs and reference capacities. A relationship module is configured to: from the lookup table, identify a first set of the reference SOCs associated with the first OCV and the reference capacities, respectively; from the lookup table, identify a second set of the reference SOCs associated with the second OCV and the reference capacities, respectively; determine changes in SOC associated with the reference capacities based on differences between ones of the first set of reference SOCs and ones of the second set of reference SOCs, respectively; determine changes in capacity based on the changes in SOC and the reference capacities, respectively; and determine an equation that relates changes in capacity to capacity based on the changes in capacity and the reference capacities, respectively. A capacity module is configured to determine a present capacity of the battery using the equation and based on the change in capacity of the battery between: (i) the measurement of the first OCV of the battery; and (ii) the measurement of the second OCV of the battery.

In further features, the capacity module is configured to solve the equation for capacity given the change in capacity between: (i) the measurement of the first OCV of the battery; and (ii) the measurement of the second OCV of the battery.

In further features, the capacity module is configured to set the present capacity based on a weighted sum of the determined present capacity and a previous value of the present capacity and to determine the weights for the weighted sum based on confidence intervals for the determined present capacity and the previous value of the present capacity.

In further features, the relationship module is configured to determine the changes in capacity based on mathematical products of the changes in SOC with the reference capacities, respectively.

In further features, the OCVs in the lookup table range from a predetermined minimum OCV to a predetermined maximum OCV.

In further features, a state of charge module is configured to determine a present SOC of the battery.

In further features, a display is located within a passenger cabin of the vehicle. A display module is configured to determine a driving range of the vehicle based on the present SOC of the battery and to display the driving range of the vehicle on the display.

In further features, an engine control module is configured to start an engine when the present SOC of the battery is less than a predetermined SOC.

In further features, a voltage sensor is configured to measure the first OCV and the second OCV of the battery.

In further features, the first storage module is configured to store the first OCV of the battery at vehicle startup when the battery was not charged or discharged for at least a predetermined period before the vehicle startup.

In further features, the second storage module is configured to store the second OCV of the battery at vehicle startup after the battery has not been charged or discharged for at least a predetermined period before a vehicle startup.

In further features, the discharge module is configured to determine the change in capacity of the battery based on current flow from the battery to an electric motor between: (i) the measurement of the first OCV of the battery; and (ii) the measurement of the second OCV of the battery.

In further features, a calibration module is separate from the vehicle and is configured to populate the lookup table via execution of a predetermined testing protocol on a second battery.

In further features, the predetermined testing protocol is the Dynamic Stress Test (DST) 100 testing protocol.

In further features, the calibration module is configured to: (i) discharge the second battery such that a present SOC of the second battery decreases by a first predetermined SOC; after (i), (ii) rest the second battery for a predetermined period; after (ii), (iii) measure a third OCV of the second battery at the present SOC of the second battery; repeat (i)-(iii) until the present SOC of the second battery is less than or equal to a second predetermined SOC; determine a change in capacity of the second battery during discharging of the second battery from an initial SOC to less than or equal to the second predetermined SOC; and determine a capacity of the second battery based on the change in capacity; and index the present SOCs in the lookup table by the third OCVs and the capacity of the second battery.

In further features, the calibration module is further configured to: determine first additional reference OCVs that are less than a minimum one of the third OCVs; determine second additional reference OCVs that are greater than a maximum one of the third OCVs; determine third additional reference OCVs that are between ones of the third OCVs; based on the present SOCs and the third OCVs: determine first additional reference SOCs corresponding to the first additional reference OCVs, respectively; determine second additional reference SOCs corresponding to the second additional reference OCVs, respectively; determine third additional reference SOCs corresponding to the third additional reference OCVs, respectively; and index the first, second, and third additional reference SOCs in the lookup table by the first, second, and third additional reference OCVs, respectively, and the capacity of the second battery.

In a feature, a method includes: selectively storing a first open circuit voltage (OCV) of a battery of a vehicle; selectively storing a second OCV of the battery of the vehicle; a determining a change in capacity of the battery between: (i) the measurement of the first OCV of the battery; and (ii) the measurement of the second OCV of the battery; from a lookup table including reference states of charge (SOCs) indexed by reference OCVs and reference capacities, identifying a first set of the reference SOCs associated with the first OCV and the reference capacities, respectively; from the lookup table, identifying a second set of the reference SOCs associated with the second OCV and the reference capacities, respectively; determining changes in SOC associated with the reference capacities based on differences between ones of the first set of reference SOCs and ones of the second set of reference SOCs, respectively; determining changes in capacity based on the changes in SOC and the reference capacities, respectively; determining an equation that relates changes in capacity to capacity based on the changes in capacity and the reference capacities, respectively; and determining a present capacity of the battery using the equation and based on the change in capacity of the battery between: (i) the measurement of the first OCV of the battery; and (ii) the measurement of the second OCV of the battery.

In further features, the method further includes solving the equation for capacity given the change in capacity between: (i) the measurement of the first OCV of the battery; and (ii) the measurement of the second OCV of the battery.

In further features, the method further includes setting present capacity based on a weighted sum of the determined present capacity and a previous value of the present capacity and to determine the weights for the weighted sum based on confidence intervals for the determined present capacity and the previous value of the present capacity.

In further features, the method further includes determining the changes in capacity based on mathematical products of the changes in SOC with the reference capacities, respectively.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a functional block diagram of an example engine control system.

FIG. 2 is a functional block diagram of an example engine and motor control system.

FIG. 3 is a functional block diagram of an example battery management module.

FIG. 4 includes an example graph illustrative of a relationship between capacity of a battery and change in capacity (dQ) of the battery generated for one set of two open circuit voltages of the battery.

FIG. 5 includes a flowchart depicting an example method of determining capacity and state of charge (SOC) of a battery.

FIG. 6 includes a functional block diagram of an example implementation of a calibration module.

FIG. 7 includes an example graph of open circuit voltage of a battery versus state of charge of the battery exhibited during multiple cycles of the battery.

FIG. 8 includes a flowchart depicting an example method of generating a lookup table of states of charge indexed by capacity and open circuit voltage.

Corresponding reference numerals indicate corresponding parts throughout the several views of the drawings.

### DETAILED DESCRIPTION

An internal combustion engine of a vehicle combusts air and fuel within cylinders to generate propulsion torque. The engine outputs torque to wheels of the vehicle via a transmission. Some types of vehicles may not include an internal combustion engine or the internal combustion engine may not be mechanically coupled to a driveline of the vehicle. For example, electric vehicles may not include an internal combustion engine.

An electric motor may be mechanically coupled to a shaft of the transmission. Under some circumstances, a hybrid control module of the vehicle may apply power to the electric motor from a battery to cause the electric motor to output torque for vehicle propulsion. Under other circumstances, the hybrid control module may disable power flow to the electric motor and allow the transmission to drive rotation of the electric motor. The electric motor generates power when driven by the transmission. Power generated by the electric motor can be used to recharge the battery when a voltage generated via the electric motor is greater than a voltage of the battery. In some examples, the voltage generated by the electric motor may be boosted (increased) to charge the battery.

A module of the vehicle determines a present capacity of the battery based on two open circuit voltages (OCVs) of the battery and a change in capacity of the battery between the taking of the two OCVs. The OCVs are taken when the battery is in steady state, such as at vehicle startup after the vehicle is shut down for at least a predetermined period.

The module determines the present capacity using a lookup table that relates capacities and open circuit voltages to states of charge. The lookup table is calibrated during vehicle design using a testing protocol that controls aging of one or more other batteries, such as the Dynamic Stress Test (DST) 100 testing protocol or the USABC protocol. The calibrated data correlates with data of batteries aged in-vehicle and therefore provides accurate capacity and state of charge estimates in-vehicle.

The total capacity of a battery decreases with age. This affects the range of the vehicle, both the total range when the battery is fully charged and the prediction of remaining range when the battery is partially discharged. According to the present disclosure, OCV measurements (voltage when the battery has rested long enough) and the Coulomb-count of amp-hours passed by the battery between OCV measurements are used to estimate the aged total capacity of the battery.

The shape of the OCV curve also varies with age. The OCV curve is part of a battery state estimation method that uses voltage as a lookup. In this example, the relevant OCV curve may be a column of a lookup table corresponding to the estimated aged total capacity.

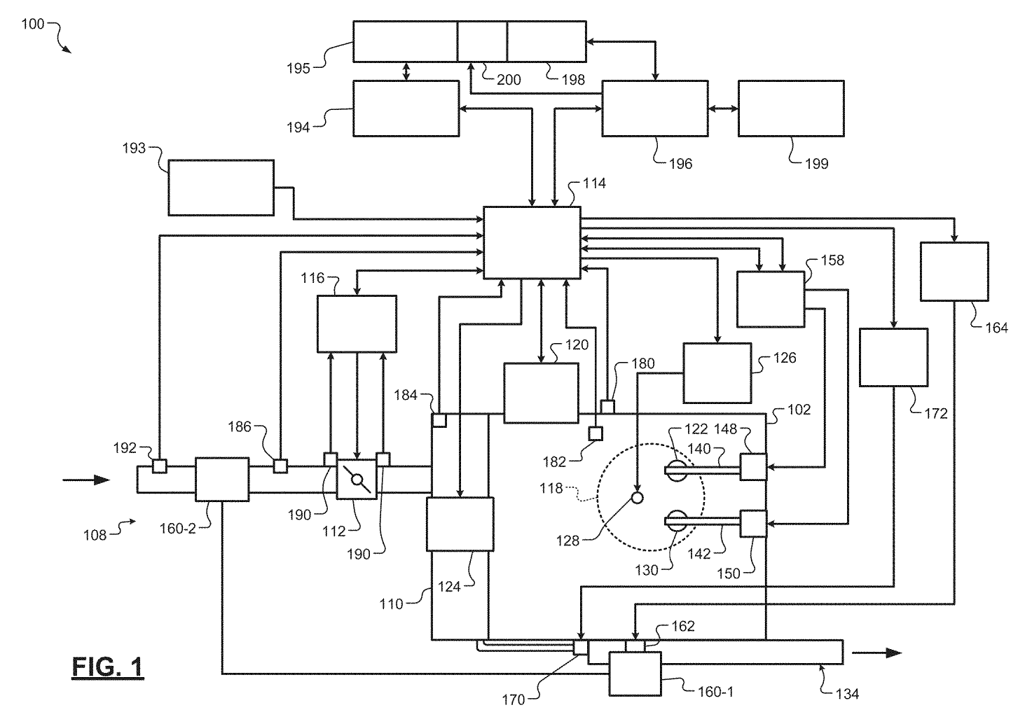

Referring now to FIG. 1, a functional block diagram of an example powertrain system 100 is presented. The powertrain system 100 of a vehicle includes an engine 102 that combusts an air/fuel mixture to produce torque. The vehicle may be non-autonomous, semi-autonomous, or autonomous.

Air is drawn into the engine 102 through an intake system 108. The intake system 108 may include an intake manifold 110 and a throttle valve 112. For example only, the throttle valve 112 may include a butterfly valve having a rotatable blade. An engine control module (ECM) 114 controls a throttle actuator module 116, and the throttle actuator module 116 regulates opening of the throttle valve 112 to control airflow into the intake manifold 110. The ECM 114 also controls starting and shutting down of the engine 102.

Air from the intake manifold 110 is drawn into cylinders of the engine 102. While the engine 102 includes multiple cylinders, for illustration purposes a single representative cylinder 118 is shown. For example only, the engine 102 may include 2, 3, 4, 5, 6, 8, 10, and/or 12 cylinders. The ECM 114 may instruct a cylinder actuator module 120 to selectively deactivate some of the cylinders under some circumstances, as discussed further below, which may improve fuel efficiency.

The engine 102 may operate using a four-stroke cycle or another suitable engine cycle. The four strokes of a four-stroke cycle, described below, will be referred to as the intake stroke, the compression stroke, the combustion stroke, and the exhaust stroke. During each revolution of a crankshaft (not shown), two of the four strokes occur within the cylinder 118. Therefore, two crankshaft revolutions are necessary for the cylinder 118 to experience all four of the strokes. For four-stroke engines, one engine cycle may correspond to two crankshaft revolutions.

When the cylinder 118 is activated, air from the intake manifold 110 is drawn into the cylinder 118 through an intake valve 122 during the intake stroke. The ECM 114 controls a fuel actuator module 124, which regulates fuel injection to achieve a desired air/fuel ratio. Fuel may be injected into the intake manifold 110 at a central location or at multiple locations, such as near the intake valve 122 of each of the cylinders. In various implementations (not shown), fuel may be injected directly into the cylinders or into mixing chambers/ports associated with the cylinders. The fuel actuator module 124 may halt injection of fuel to cylinders that are deactivated.

The injected fuel mixes with air and creates an air/fuel mixture in the cylinder 118. During the compression stroke, a piston (not shown) within the cylinder 118 compresses the air/fuel mixture. The engine 102 may be a compression-ignition engine, in which case compression causes ignition of the air/fuel mixture. Alternatively, the engine 102 may be a spark-ignition engine, in which case a spark actuator module 126 energizes a spark plug 128 in the cylinder 118 based on a signal from the ECM 114, which ignites the air/fuel mixture. Some types of engines, such as homogenous charge compression ignition (HCCI) engines may perform both compression ignition and spark ignition. The timing of the spark may be specified relative to the time when the piston is at its topmost position, which will be referred to as top dead center (TDC).

The spark actuator module 126 may be controlled by a timing signal specifying how far before or after TDC to generate the spark. Because piston position is directly related to crankshaft rotation, operation of the spark actuator module 126 may be synchronized with the position of the crankshaft. The spark actuator module 126 may disable provision of spark to deactivated cylinders or provide spark to deactivated cylinders.

During the combustion stroke, the combustion of the air/fuel mixture drives the piston down, thereby driving the crankshaft. The combustion stroke may be defined as the time between the piston reaching TDC and the time when the piston returns to a bottom most position, which will be referred to as bottom dead center (BDC).

During the exhaust stroke, the piston begins moving up from BDC and expels the byproducts of combustion through an exhaust valve 130. The byproducts of combustion are exhausted from the vehicle via an exhaust system 134.

The intake valve 122 may be controlled by an intake camshaft 140, while the exhaust valve 130 may be controlled by an exhaust camshaft 142. In various implementations, multiple intake camshafts (including the intake camshaft 140) may control multiple intake valves (including the intake valve 122) for the cylinder 118 and/or may control the intake valves (including the intake valve 122) of multiple banks of cylinders (including the cylinder 118). Similarly, multiple exhaust camshafts (including the exhaust camshaft 142) may control multiple exhaust valves for the cylinder 118 and/or may control exhaust valves (including the exhaust valve 130) for multiple banks of cylinders (including the cylinder 118). While camshaft based valve actuation is shown and has been discussed, camless valve actuators may be implemented. While separate intake and exhaust camshafts are shown, one camshaft having lobes for both the intake and exhaust valves may be used.

The cylinder actuator module 120 may deactivate the cylinder 118 by disabling opening of the intake valve 122 and/or the exhaust valve 130. The time when the intake valve 122 is opened may be varied with respect to piston TDC by an intake cam phaser 148. The time when the exhaust valve 130 is opened may be varied with respect to piston TDC by an exhaust cam phaser 150. A phaser actuator module 158 may control the intake cam phaser 148 and the exhaust cam phaser 150 based on signals from the ECM 114. In various implementations, cam phasing may be omitted. Variable valve lift (not shown) may also be controlled by the phaser actuator module 158. In various other implementations, the intake valve 122 and/or the exhaust valve 130 may be controlled by actuators other than a camshaft, such as electromechanical actuators, electrohydraulic actuators, electromagnetic actuators, etc.

The engine 102 may include zero, one, or more than one boost device that provides pressurized air to the intake manifold 110. For example, FIG. 1 shows a turbocharger including a turbocharger turbine 160-1 that is driven by exhaust gases flowing through the exhaust system 134. A supercharger is another type of boost device.

The turbocharger also includes a turbocharger compressor 160-2 that is driven by the turbocharger turbine 160-1 and that compresses air leading into the throttle valve 112. A wastegate 162 controls exhaust flow through and bypassing the turbocharger turbine 160-1. Wastegates can also be referred to as (turbocharger) turbine bypass valves. The wastegate 162 may allow exhaust to bypass the turbocharger turbine 160-1 to reduce intake air compression provided by the turbocharger. The ECM 114 may control the turbocharger via a wastegate actuator module 164. The wastegate actuator module 164 may modulate the boost of the turbocharger by controlling an opening of the wastegate 162.

A cooler (e.g., a charge air cooler or an intercooler) may dissipate some of the heat contained in the compressed air charge, which may be generated as the air is compressed. Although shown separated for purposes of illustration, the turbocharger turbine 160-1 and the turbocharger compressor 160-2 may be mechanically linked to each other, placing intake air in close proximity to hot exhaust. The compressed air charge may absorb heat from components of the exhaust system 134.

The engine 102 may include an exhaust gas recirculation (EGR) valve 170, which selectively redirects exhaust gas back to the intake manifold 110. The EGR valve 170 may receive exhaust gas from upstream of the turbocharger turbine 160-1 in the exhaust system 134. The EGR valve 170 may be controlled by an EGR actuator module 172.

Crankshaft position may be measured using a crankshaft position sensor 180. An engine speed may be determined based on the crankshaft position measured using the crankshaft position sensor 180. A temperature of engine coolant may be measured using an engine coolant temperature (ECT) sensor 182. The ECT sensor 182 may be located within the engine 102 or at other locations where the coolant is circulated, such as a radiator (not shown).

A pressure within the intake manifold 110 may be measured using a manifold absolute pressure (MAP) sensor 184. In various implementations, engine vacuum, which is the difference between ambient air pressure and the pressure within the intake manifold 110, may be measured. A mass flow rate of air flowing into the intake manifold 110 may be measured using a mass air flow (MAF) sensor 186. In various implementations, the MAF sensor 186 may be located in a housing that also includes the throttle valve 112.

Position of the throttle valve 112 may be measured using one or more throttle position sensors (TPS) 190. A temperature of air being drawn into the engine 102 may be measured using an intake air temperature (IAT) sensor 192. One or more other sensors 193 may also be implemented.

The other sensors 193 may include an accelerator pedal position (APP) sensor, a brake pedal position (BPP) sensor, a clutch pedal position (CPP) sensor (e.g., in the case of a manual transmission), or may include one or more other types of sensors. An APP sensor measures a position of an accelerator pedal within a passenger cabin of the vehicle. A BPP sensor measures a position of a brake pedal within a passenger cabin of the vehicle. A CPP sensor measures a position of a clutch pedal within the passenger cabin of the vehicle. The other sensors 193 may also include one or more acceleration sensors that measure longitudinal (e.g., fore/aft) acceleration of the vehicle and latitudinal acceleration of the vehicle. An accelerometer is an example type of acceleration sensor, although other types of acceleration sensors may be used. The ECM 114 may use signals from the sensors to make control decisions for the engine 102.

The ECM 114 may communicate with a transmission control module 194, for example, to coordinate engine operation with gear shifts in a transmission 195. The transmission 195 transfers torque to wheels of the vehicle. The ECM 114 may communicate with a hybrid control module 196, for example, to coordinate operation of the engine 102 and an electric motor 198. While the example of one electric motor is provided, multiple electric motors may be implemented.

The electric motor 198 may be a permanent magnet electric motor or another suitable type of electric motor that outputs voltage based on back electromagnetic force (EMF) when free spinning, such as a direct current (DC) electric motor or a synchronous electric motor. In various implementations, various functions of the ECM 114, the transmission control module 194, and the hybrid control module 196 may be integrated into one or more modules.

Each system that varies an engine parameter may be referred to as an engine actuator. Each engine actuator has an associated actuator value. For example, the throttle actuator module 116 may be referred to as an engine actuator, and the throttle opening area may be referred to as the actuator value. In the example of FIG. 1, the throttle actuator module 116 achieves the throttle opening area by adjusting an angle of the blade of the throttle valve 112.

The spark actuator module 126 may also be referred to as an engine actuator, while the corresponding actuator value may be the amount of spark advance relative to cylinder TDC. Other engine actuators may include the cylinder actuator module 120, the fuel actuator module 124, the phaser actuator module 158, the wastegate actuator module 164, and the EGR actuator module 172. For these engine actuators, the actuator values may correspond to a cylinder activation/deactivation sequence, fueling rate, intake and exhaust cam phaser angles, target wastegate opening, and EGR valve opening, respectively.

The ECM 114 may control the actuator values in order to cause the engine 102 to output torque based on a torque request. The ECM 114 may determine the torque request, for example, based on one or more driver inputs, such as an APP, a BPP, a CPP, and/or one or more other suitable driver inputs. The ECM 114 may determine the torque request, for example, using one or more functions or lookup tables that relate the driver input(s) to torque requests.

Under some circumstances, the hybrid control module 196 controls the electric motor 198 to output torque, for example, to supplement engine torque output. The hybrid control module 196 may also control the electric motor 198 to output torque for vehicle propulsion at times when the engine 102 is shut down. In various implementations, the engine 102 may be left shut down and the electric motor 198 may be used for propulsion. The ECM 114 may start and run the engine 102 to generate electrical power for the electric motor 198, for example, when a state of charge (SOC) is less than a predetermined SOC or an estimated range of use of the electric motor 198 is less than a predetermined range.

The hybrid control module 196 applies electrical power from battery 199 to the electric motor 198 to cause the electric motor 198 to output positive torque. The battery 199 may include, for example, one or more individual batteries, such as Lithium Ion (Li) batteries or batteries having another type of chemistry. The battery 199 may be dedicated for power flow to and from the electric motor 198, and one or more other batteries may supply power for other vehicle functions.

The electric motor 198 may output torque, for example, to an input shaft of the transmission 195 or to an output shaft of the transmission 195. A clutch 200 is engaged to couple the electric motor 198 to the transmission 195 and disengaged to decouple the electric motor 198 from the transmission 195. One or more gearing devices may be implemented between an output of the clutch 200 and an input of the transmission 195 to provide a predetermined ratio between rotation of the electric motor 198 and rotation of the input of the transmission 195. A second clutch (not shown) may be engaged and disengaged to couple and decouple the engine 102 to and from the transmission 195.

The hybrid control module 196 may also selectively convert mechanical energy of the vehicle into electrical energy. More specifically, the electric motor 198 generates and outputs power via back EMF when the electric motor 198 is being driven by the transmission 195 and the hybrid control module 196 is not applying power to the electric motor 198 from the battery 199. The hybrid control module 196 may charge the battery 199 via the power output by the electric motor 198. This may be referred to as regeneration.

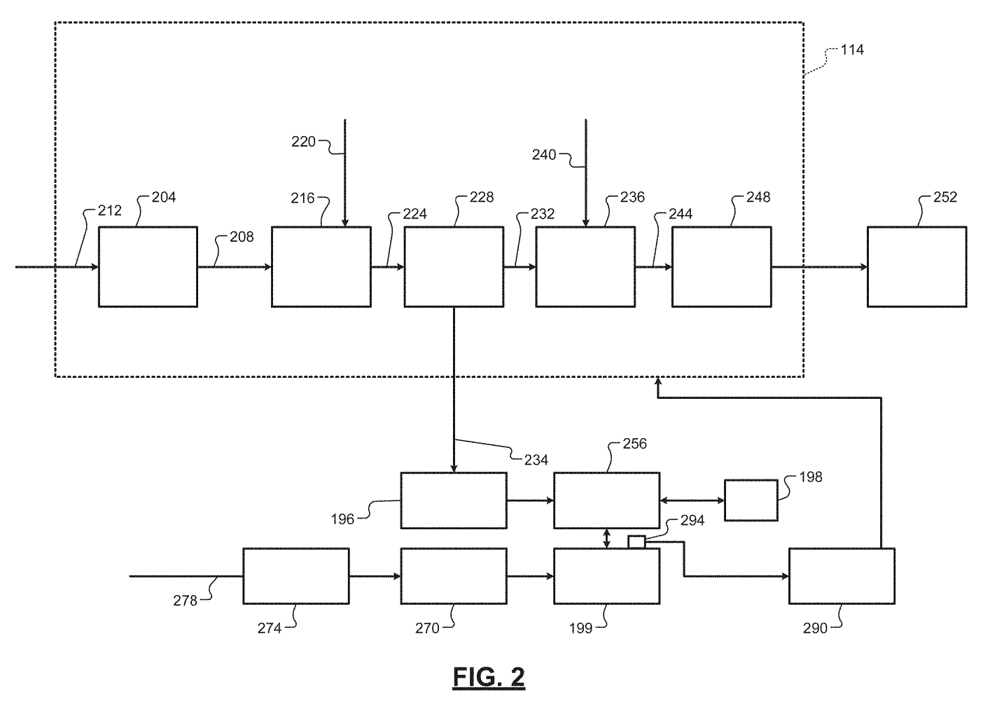

Referring now to FIG. 2, a functional block diagram of an example engine control system is presented. The ECM 114 includes a driver torque module 204 that determines a driver torque request 208 based on driver input 212. The driver input 212 may include, for example, an accelerator pedal position (APP), a brake pedal position (BPP), and/or cruise control input. In various implementations, the cruise control input may be provided by an adaptive cruise control system that attempts to maintain at least a predetermined distance between the vehicle and objects in a path of the vehicle. The driver torque module 204 determines the driver torque request 208 based on one or more lookup tables that relate the driver inputs to driver torque requests. The APP and BPP may be measured using one or more APP sensors and BPP sensors, respectively.

The driver torque request 208 is an axle torque request. Axle torques (including axle torque requests) refer to torque at the wheels. As discussed further below, propulsion torques (including propulsion torque requests) are different than axle torques in that propulsion torques may refer to torque at a transmission input shaft.

An axle torque arbitration module 216 arbitrates between the driver torque request 208 and other axle torque requests 220. Axle torque (torque at the wheels) may be produced by various sources including the engine 102 and/or one or more electric motors, such as the electric motor 198. Examples of the other axle torque requests 220 include, but are not limited to, a torque reduction requested by a traction control system when positive wheel slip is detected, a torque increase request to counteract negative wheel slip, brake management requests to reduce axle torque to ensure that the axle torque does not exceed the ability of the brakes to hold the vehicle when the vehicle is stopped, and vehicle over-speed torque requests to reduce the axle torque to prevent the vehicle from exceeding a predetermined speed. The axle torque arbitration module 216 outputs one or more axle torque requests 224 based on the results of arbitrating between the received axle torque requests 208 and 220.

A hybrid module 228 may determine how much of the one or more axle torque requests 224 should be produced by the engine 102 and how much of the one or more axle torque requests 224 should be produced by the electric motor 198. The example of the electric motor 198 will be continued for simplicity, but multiple electric motors may be used.

The hybrid module 228 outputs one or more engine torque requests 232 to a propulsion torque arbitration module 236. The engine torque requests 232 indicate a requested torque output of the engine 102. The hybrid module 228 also outputs a motor torque request 234 to the hybrid control module 196. The motor torque request 234 indicates a requested torque output (positive or negative) of the electric motor 198. In vehicles where the engine 102 is omitted or is not connected to output propulsion torque for the vehicle, the axle torque arbitration module 216 may output one axle torque request and the motor torque request 234 may be equal to that axle torque request.

The propulsion torque arbitration module 236 converts the engine torque requests 232 from an axle torque domain (torque at the wheels) into a propulsion torque domain (e.g., torque at an input shaft of the transmission). The propulsion torque arbitration module 236 arbitrates the converted torque requests with other propulsion torque requests 240. Examples of the other propulsion torque requests 240 include, but are not limited to, torque reductions requested for engine over-speed protection and torque increases requested for stall prevention. The propulsion torque arbitration module 236 may output one or more propulsion torque requests 244 as a result of the arbitration.

An actuator control module 248 controls actuators 252 of the engine 102 based on the propulsion torque requests 244. Based on the propulsion torque requests 244, the actuator control module 248 may control opening of the throttle valve 112, timing of spark provided by spark plugs, timing and amount of fuel injected by fuel injectors, cylinder actuation/deactivation, intake and exhaust valve phasing, output of one or more boost devices (e.g., turbochargers, superchargers, etc.), opening of the EGR valve 170, and/or one or more other engine actuators. In various implementations, the propulsion torque requests 244 may be adjusted or modified before use by the actuator control module 248, such as to create a torque reserve.

The hybrid control module 196 controls switching of an inverter module 256 based on the motor torque request 234. Switching of the inverter module 256 controls power flow from the battery 199 to the electric motor 198. As such, switching of the inverter module 256 controls torque of the electric motor 198. The inverter module 256 also converts power generated by the electric motor 198 and outputs power to the battery 199, for example, to charge the battery 199.

The inverter module 256 includes a plurality of switches. The switches are switched to convert DC power from the battery 199 into alternating current (AC) power and apply the AC power to the electric motor 198 to drive the electric motor 198. For example, the inverter module 256 may convert the DC power from the battery 199 into 3-phase AC power and apply the 3-phase AC power to (e.g., a, b, and c, or u, v, and w) stator windings of the electric motor 198. Magnetic flux produced via current flow through the stator windings drives a rotor of the electric motor 198. The rotor is connected to and drives rotation of an output shaft of the electric motor 198.

In various implementations, one or more filters may be electrically connected between the inverter module 256 and the battery 199. The one or more filters may be implemented, for example, to filter power flow to and from the battery 199. As an example, a filter including one or more capacitors and resistors may be electrically connected in parallel with the inverter module 256 and the battery 199.

A charger module 270 is connected to a charging port 274 of the vehicle and charges the battery 199 using AC power received via a cord 278 connected between an AC power source (e.g., a utility) and the charging port 274. The AC power may be, for example, 110 V AC power or 220 V AC power. The charger module 270 converts the AC power received into DC power to charge the battery 199.

A battery management module 290 monitors operating parameters of the battery 199 measured by various sensors, such as one or more voltages of the battery 199, current flow to and from the battery 199, one or more temperatures of the battery 199, and other operating parameters. Operating parameters of the battery 199 may be measured by sensors collectively illustrated for simplicity by 294. In various implementations, the battery management module 290 may estimate one or more operating parameters of the battery 199, such as a present capacity of the battery 199 and a present state of charge (SOC) of the battery 199.

The battery management module 290 stores open circuit voltages (OCVs) of the battery 199, for example, when the vehicle is started and has been at rest for sufficient time prior to the startup for the battery 199 to reach steady state. The battery management module 290 also tracks change in capacity (e.g., in Amp hours) of the battery 199 during use of the battery 199.

Using a lookup table of capacities and OCVs to SOC, the battery management module 290 generates a relationship for present capacity of the battery 199 as a function of battery capacity consumed. Using the change in capacity of the battery 199 between two OCVs, the battery management module 290 determines a present capacity of the battery 199 at vehicle startup. The lookup table is calibrated by the vehicle manufacturer via testing and is stored in the vehicle, as discussed further below.

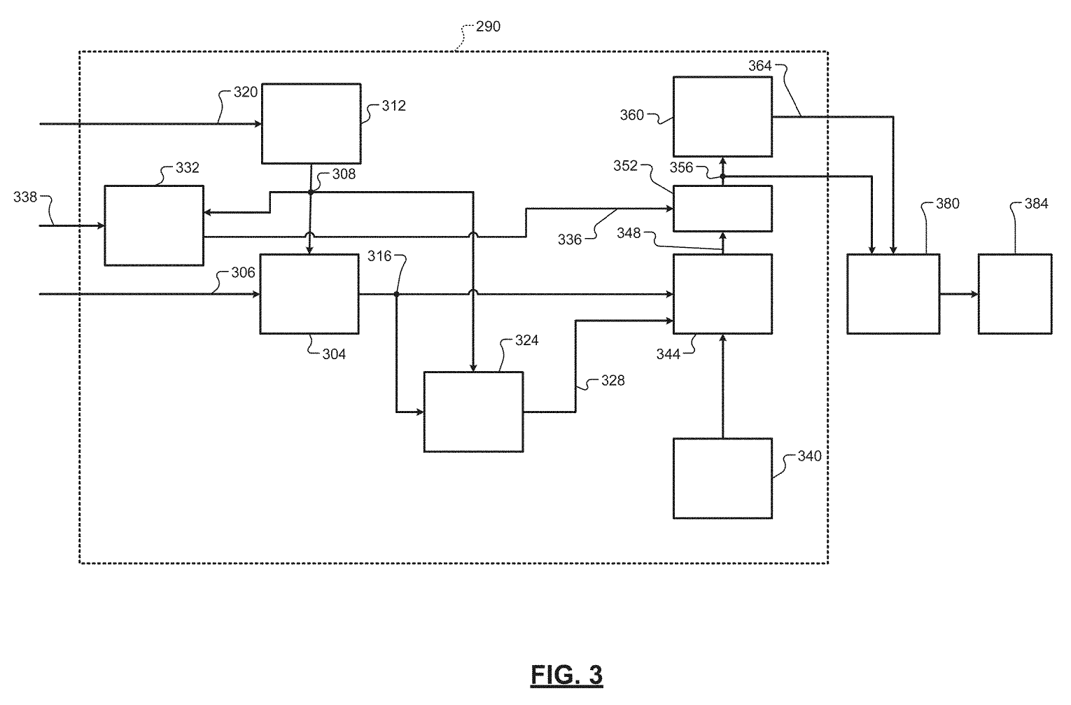

FIG. 3 includes a functional block diagram of an example implementation of the battery management module 290. A first storage module 304 stores a voltage 306 of the battery 199 in response to generation of a trigger signal 308 by a triggering module 312. The voltage 306 of the battery 199 is an output voltage of the battery 199 to the inverter module 256. The voltage 306 is measured by one of the sensors 294, such as a voltage sensor. The first storage module 304 outputs the stored voltage as a first OCV (open circuit voltage) 316 of the battery 199. The first storage module 304 replaces the stored voltage with the (present) voltage 306 each time that the trigger signal 308 is generated.

The triggering module 312 generates the trigger signal 308 when the vehicle is started and the vehicle was shut off for at least a predetermined period prior to the startup. The predetermined period is calibrated such that the battery 199 reaches steady state when the predetermined period has passed after the last vehicle shutdown. The predetermined period may be, for example, one hour, more than one hour, or another suitable period. The predetermined period may be a function of temperature as a relaxation time constant of the battery 199 is temperature dependent.

Vehicle startup 320 may be indicated by an ignition state of the vehicle transitioning from off to another state, such as on, run, accessory, or crank. The ignition state may transition from off to another state, for example, in response to user actuation of one or more ignition keys, buttons, and/or switches including buttons and switches of the vehicle and buttons and switches of remote devices, such as key fobs. Vehicle shutdown may be indicated by the ignition state of the vehicle transitioning to off. The ignition state may transition to off, for example, in response to user actuation of the one or more ignition keys, buttons, and/or switches.

A second storage module 324 stores the first OCV 316 of the battery 199 (before the first OCV 316 is updated) in response to the generation of the trigger signal 308 by the triggering module 312. The second storage module 324 outputs the stored voltage as a second OCV 328 of the battery 199. The second storage module 324 replaces the stored voltage with the first OCV 316 each time that the trigger signal 308 is generated.

A change module 332 monitors a change in capacity (e.g., discharge) of the battery 199 between consecutive instances of the generation of the trigger signal 308. The change module 332 determines a change in capacity 336 between consecutive times when the trigger signal 308 is generated. The change in capacity 336 corresponds to a change in capacity (dQ) of the battery 199 that occurred between the consecutive times when the trigger signal 308 is generated. The change in capacity 336 therefore corresponds to the change in capacity that occurred between the time when the first OCV 316 was stored and the time when the second OCV 328 was stored. The change in capacity 336 is Coulomb count of signed amp-hours, that is, the time-integral of current, between the instants of the two OCV triggers. The change module 332 may determine the change in capacity, for example, based on current 338 flow to and from the battery 199 between the consecutive times.

While the example of two storage modules is provided, more than two storage modules may be implemented to store a log of OCV measurements and, for each OCV in the log, the change in capacity between that OCV and the previous entry in the log. When two OCV entries in the log are sufficiently separated, the capacity update function described below is initiated. Two OCV entries may be considered sufficiently separated, for example, when the absolute value of a difference between the two OCVs is greater than a threshold value and/or the absolute value of a difference between the corresponding SOC values of the two OCVs (as determined by interpolation in the column of the lookup table described below) corresponding to the most recent estimate of the capacity is greater than a threshold value. Other examples for determining sufficient separation are also possible. The entries in the OCV history table may include a date stamp, and entries that are determined to be too old may be purged from the log. If more than one pair of entries in the log satisfy the criterion for sufficient separation, the most recent pair may be selected or the most widely separated pair may be selected to be used to update the capacity estimate. Alternatively, we could generate estimates from several qualifying pairs and compute a composite estimate as a weighted sum of the estimates. In the description below, “first OCV” and “second OCV” refer to two OCV values that are chosen for the capacity update and are not necessarily the first and second entries in the OCV log.

A lookup table (LUT) 340 includes a mapping of (reference) open circuit voltages and (reference) scaled capacities to (reference) SOCs. The scaled capacities correspond to fully charged capacities. The LUT 340 is calibrated as discussed below, for example, by a manufacturer of the vehicle. An example of such a lookup table is provided below.

| | Scaled Capacity | | | | | | | |
|---|---|---|---|---|---|---|---|---|
| OCV | SC1 | SC2 | SC3 | SC4 | . . . | . . . | . . . | SCM |
| OCVMin | SOC1, 1 | SOC2, 1 | SOC3, 1 | SOC4, 1 | . . . | . . . | . . . | SOC1, M |
| OCV2 | SOC2, 1 | . . . | . . . | | | | | SOC2, M |
| OCV3 | . . . | | . . . | . . . | | | | |
| OCV4 | | | | | . . . | | | . . . |
| . . . | | | | | . . . | . . . | . . . | . . . |
| OCV Max | SOCMax, 1 | | | | | | | SOCMax, X |

Where SC1 is a first scaled capacity, SC2 is a second scaled capacity, . . . , SCM is an M-th scaled capacity, OCVMin is a minimum OCV of the battery 199, OCV2 is a second OCV of the battery 199, OCV3 is a third OCV of the battery 199, . . . , OCVMax is a maximum OCV of the battery 199, and SOCY,Z is a SOC of the battery 199 corresponding to OCV of the Y-th row of the LUT 340 and the scaled capacity of the Z-th column of the LUT 340, where Y is an integer ranging from 1 to the number of OCV rows and Z is an integer ranging from 1 to the number of scaled capacity columns (i.e., M). The OCVs of the LUT 340 may be provided for each predetermined increment (e.g., 0.01 V) between the minimum and maximum OCVs. The rows may be ordered in ascending order of OCV, while the columns may be ordered in descending order of scaled capacity. While an example format for the LUT 340 is provided above, another suitable format may be used.

Based on the first OCV 316, the second OCV 328, and data from the LUT 340, when the trigger signal 308 is generated, a relationship module 344 generates a relationship 348 that relates change in capacity (dQ) to estimated present capacity of the battery 199. The relationship 348 may be in the form of, for example, a LUT or an equation.

Using the example format of the LUT 340 provided above, the relationship module 344 identifies a first row of the LUT 340 for an OCV that matches the first OCV 316. The relationship module 344 identifies a second row of the LUT 340 for an OCV that matches the second OCV 328. For example, the relationship module 344 may identify the row corresponding to the third OCV (OCV3) and the seventh OCV (OCV7). An example illustration of a table including these rows and columns is provided below.

| | SC1 | SC2 | SC3 | SC4 | . . . | . . . | . . . | SCM |
|---|---|---|---|---|---|---|---|---|
| OCV3 | SOC3, 1 | SOC3, 2 | SOC3, 3 | SOC3, 4 | . . . | . . . | . . . | SOC3, M |
| OCV7 | SOC7, 1 | . . . | . . . | | | | | SOC7, M |

The relationship module 344 then determines changes in SOC for the scaled capacities based on differences between the values of the first and second rows, respectively. For example, using the above example of the row corresponding to the third OCV (OCV3) and the row corresponding to the seventh OCV (OCV7), the relationship module 344 determines a first change in SOC for the first column based on a difference between SOC3, 1 (i.e., in the third row and the first column) and SOC 7,1 (i.e., in the seventh row and the first column), a second change in SOC for the second column based on a difference between SOC3, 2 (i.e., in the third row and the second column) and SOC 7,2 (i.e., in the seventh row and the second column), . . . , and an M-th change in SOC for the M-th column based on a difference between SOC3, M (i.e., in the third row and the M-th column) and SOC 7,M (i.e., in the seventh row and the M-th column). An example illustration of a table including these columns and a row for change in SOC is provided below.

| | SC1 | SC2 | SC3 | SC4 | . . . | . . . | . . . | SCM |
|---|---|---|---|---|---|---|---|---|
| ΔSOC | ΔSOC1 | ΔSOC2 | ΔSOC3 | ΔSOC4 | . . . | . . . | . . . | ΔSOCM |

ΔSOC1 is the change in SOC of the first column, ΔSOC2 is the change in SOC of the second column, and ΔSOCM is the change in SOC of the M-th column.

When the first OCV 316 falls between two OCV entries in the LUT 340, the corresponding SOC in each column is determined by the relationship module 344 by interpolation. For example, if the OCV falls between OCV3 and OCV4, then a piecewise linear interpolation rule for determining the SOC value in column SCj is

$${SOC}_{j} = \frac{( OCV 4 - OCV ) {SOC}_{3 , j} + ( OCV - OCV 3 ) {SOC}_{4 , j}}{OCV 4 - OCV 3} .$$

Other interpolation rules, such as nearest neighbor or cubic interpolation, could be used instead. Having determined a first SOC_{j,a} and a second SOC_{j,b} corresponding to first OCV 316 and second OCV 328, respectively,

ΔSOCⱼ=SOC_{j,b}−SOC_{j,a}.

The relationship module 344 then determines a change in capacity (dQ) for each of the columns by multiplying the change in SOC of the columns with the scaled capacities of the columns, respectively. For example, the relationship module 344 determines a first capacity change (dQ1=SC1*ΔSOC1) for the first column based on the first change in SOC (ΔSOC1) multiplied by the scaled capacity of the first column (SC1), a second capacity change (dQ2) for the second column based on the second change in SOC (ΔSOC2) multiplied by the scaled capacity of the second column (SC2), . . . and an M-th capacity change (dQM) for the M-th column based on the M-th change in SOC (ΔSOCM) multiplied by the scaled capacity of the M-th column (SCM). An example illustration of a table including these columns and a row for change in capacity (dQ) is provided below.

| | SC1 | SC2 | SC3 | SC4 | . . . | . . . | . . . | SCM |
|---|---|---|---|---|---|---|---|---|
| dQ | dQ1 | dQ2 | dQ3 | dQ4 | . . . | . . . | . . . | dQM |

dQ1 is the first change in capacity associated with the first scaled capacity (SC1) of the first column, dQ2 is the second change in capacity associated with the second scaled capacity (SC2) of the second column, and dQM is the M-th change in capacity associated with the M-th scaled capacity (SCM) of the M-th column.

The above table reflects the relationship 348 between changes in capacity and capacities of the battery 199. The relationship module 344 may use the table above or determine an equation (e.g., polynomial, quadratic, or linear) relating changes in capacity and capacity by, for example, fitting a curve to the points of the above table.

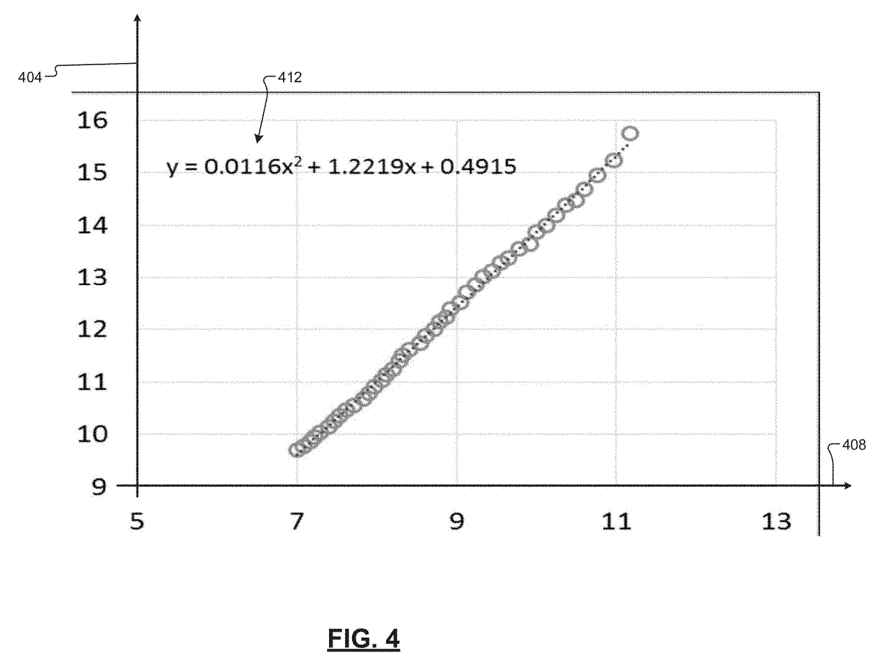

FIG. 4 includes an example graph of points illustrative of a relationship between capacity 404 and change in capacity (dQ) 408 generated for one set of two OCVs. Different combinations of two OCVs yield different relationships. FIG. 4 also includes an example equation 412 determined for the points. Different combinations of two OCVs yield different equations.

Referring back to FIG. 3, when the trigger signal 308 is generated to update capacity (capacity update trigger), a capacity module 352 determines a present capacity 356 of the battery 199 based on the change in capacity 336 using the relationship 348. In the example of an equation, the capacity module 352 may solve the equation for capacity by inserting the change in capacity 336 into the equation. In the example of a LUT, the capacity module 352 may determine the capacity 356 using linear interpolation by identifying the two closest changes in capacity to the change in capacity 336 from the LUT, identifying the two capacities associated with the two closest changes in capacity, and determining the capacity using linear interpolation or in another suitable manner. The capacity module 352 may update the capacity 356 of the battery 199 during the subsequent use of the vehicle based on current flow to and from the battery 199.

The capacity module 352 may attach a confidence interval to the capacity 336. For example, the confidence interval may reflect increased confidence (e.g., have a lower value) in the calculation if the two OCVs are more widely separated and the confidence interval may reflect a decreased confidence (e.g., have a higher value) if the time between the two OCVs is large. When the capacity module 352 updates the capacity 336, the capacity module 352 may combine the existing total capacity estimate with the newly computed total capacity estimate in a weighted sum that gives more weight to the one of the estimates having a smaller confidence interval. The confidence interval of the estimate before the update degrades (grows/increases) with time, hence favoring the new estimate when it is accurate. The capacity module 352 may set the confidence interval, for example, based on the accuracy of the OCV voltage measurements, the accuracy of the Coulomb-counted capacity between OCV measurements, and/or the time since the capacity was last updated. The capacity module 352 may determine the confidence interval, for example, using a Kalman filter methodology or in another suitable manner. The capacity module 352 may determine the weights based on the confidence intervals of the capacities.

A state of charge (SOC) module 360 may determine a SOC 364 of the battery 199 using the aged OCV curve stored in the LUT 340.

One or more actions may be taken based on the SOC 364 and/or the capacity 356 of the battery 199. For example, a display control module 380 may display the SOC 364 and/or the capacity 356 of the battery 199 on a display 384 within a passenger cabin of the vehicle. Additionally or alternatively, the display control module 380 may determine a driving range (distance) of the vehicle based on the SOC 364 and/or the capacity 356 and display the driving range on the display 384. The driving range may correspond to an estimated maximum distance that the vehicle could travel using only power from the battery 199 for propulsion.

Additionally or alternatively, the hybrid control module 196 may control switching of the inverter module 256 based on the SOC 364 and/or the capacity 356. The hybrid control module 196 may, for example, control switching of the inverter module 256 to increase charging of the battery 199 when the capacity 356 is less than a predetermined capacity and/or the SOC 364 is less than a predetermined SOC. Additionally or alternatively, the ECM 114 may start the engine 102 (if the engine 102 is off) when the capacity 356 is less than the predetermined capacity and/or the SOC 364 is less than the predetermined SOC. The engine 102 may then be used to charge the battery 199 and generate power for the electric motor 198.

While the example of each trigger generating a new capacity update is described, one or more triggers may be generated between successive capacity updates. For example, two successive OCVs might not be separated enough to estimate/update capacity. Both may be logged, however, one set of data may be deleted later, for example, based on having an age that is greater than a predetermined age.

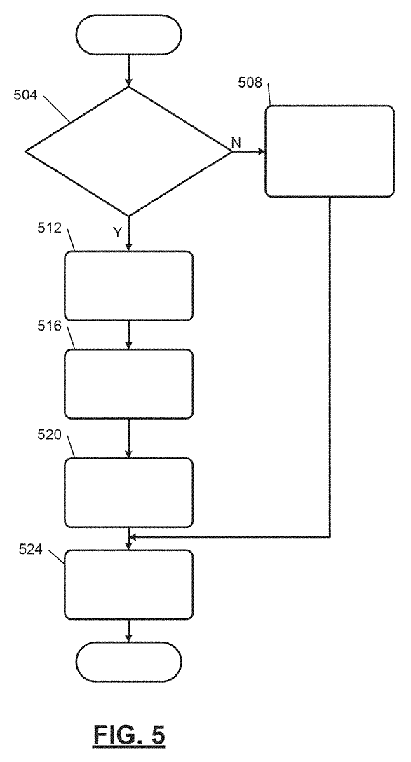

FIG. 5 includes a flowchart depicting an example method of determining the capacity 356 and the SOC 364 of the battery 199. Control begins at startup of the vehicle, such as when the ignition state transitions from off to another state. At 504, the triggering module 312 determines whether the period since the vehicle was last shut down is greater than the predetermined period (such that the battery 199 has reached steady state). If 504 is false, the capacity module 352 may set the capacity 356 to the capacity 356 when the vehicle was last shut down at 508 (unless charging of the battery 199 occurred while the vehicle was shutdown), and control may continue with 524. If 504 is true, control continues with 512.

In various implementations, before continuing with 512, the capacity module 352 may determine whether to update the capacity 336. For example, the capacity module 352 may determine whether a difference between the first OCV 316 and the present voltage 306 of the battery 199 is greater than a predetermined value. If true, control may continue with 512. If false, control may transfer to 508.

At 512, the second storage module 324 sets the second OCV 328 to the first OCV 316. The first storage module 304 then updates the first OCV 316 to the voltage 306 of the battery 199. At 516, the relationship module 344 determines the relationship 348 between change in capacity (dQ) and capacity based on the first OCV 316, the second OCV 328, and the data in the LUT 340, as described above.

At 520, the capacity module 352 determines the (present) capacity 356 of the battery 199 based on the change in capacity 336 (between the first and second OCVs 316 and 328) using the relationship 348. At 524, the SOC module 360 determines the SOC 364 of the battery 199 based on the capacity 356. Thereafter, during use of the vehicle, the capacity module 352 updates the capacity 356 based on the current flow 338 to and from the battery 199.

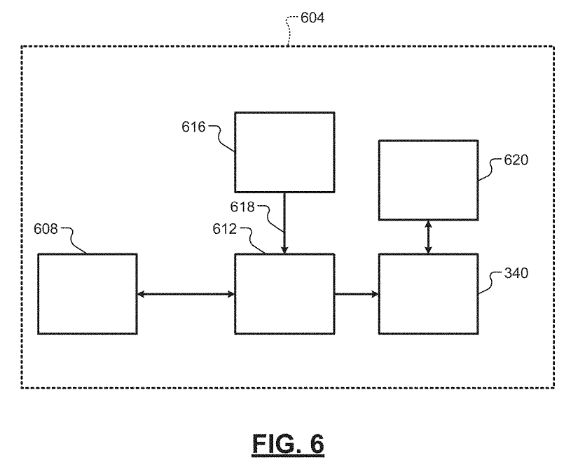

FIG. 6 is a functional block diagram of an example calibration module 604 that calibrates the LUT 340 for the vehicle and other vehicles having the same battery as the vehicle. A testing and storage module 612 cycles one or more batteries, such as battery 608, from charged to discharged according to a predetermined testing protocol. The predetermined testing protocol may be, for example, the Dynamic Stress Test 100 protocol or another suitable testing protocol.

Pursuant to the predetermined testing protocol, the testing and storage module 612 fully charges the battery 608. From fully charged, the testing and storage module 612 discharges the battery 608 by a predetermined amount (e.g., 5 or 10 percent of SOC) then lets the battery 608 rest for at least the predetermined period to reach steady state. After resting for at least the predetermined period, the reference OCV is recorded, and then the testing and storage module 612 discharges the battery 608 by the predetermined amount then lets the battery 608 rest for at least the predetermined period to reach steady state. The testing and storage module 612 continues this until the SOC of the battery 608 is less than or equal to a predetermined SOC, such as zero % SOC.

A cycle module 616 increments a cycle count 618 each time the battery 608 is transitioned from fully charged to having an SOC that is less than or equal to the predetermined SOC.

The testing and storage module 612 monitors current flow to the battery 608 and determines the change in capacity of the battery 608 during discharging of the battery 608 from fully charged to having an SOC that is less than or equal to the predetermined SOC. Each predetermined number of cycles (e.g., every 100 cycles), the testing and storage module 612 records data (the OCV, SOC, and capacity) for the battery 608. More specifically, the testing and storage module 612 records the OCV each time that the battery 608 has been discharged by the predetermined amount/SOC (after letting the battery 608 rest for at least the predetermined period) and the associated SOC of the battery. The testing and storage module 612 also records the change in capacity (i.e., discharge, such as in Ah) of the battery 608 during the discharging.

Thus, every predetermined number of cycles (e.g., at every state of battery life), the testing and storage module 612 obtains a set of data that includes (i) the actual discharge (or change in capacity) and (ii) a lookup table of OCVs and the corresponding SOCs. The SOCs of the table of a cycle are each separated by the predetermined amount of discharging.

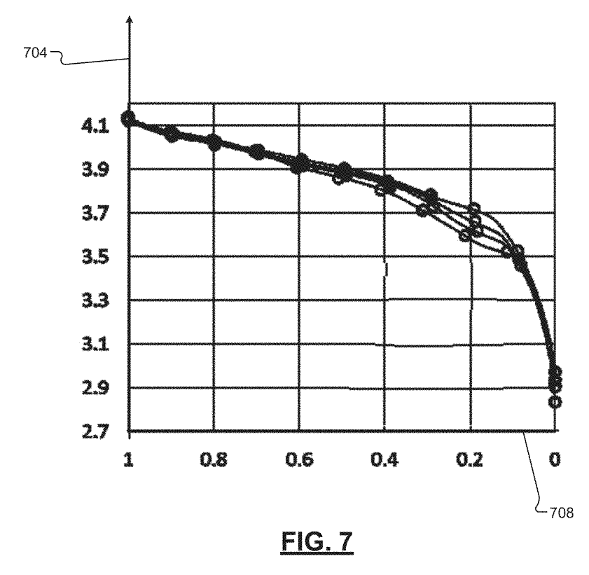

FIG. 7 includes an example graph of OCV 704 versus SOC 708. The graph includes points (of OCV and the corresponding SOC) taken during execution of different cycle numbers of the predetermined testing protocol.

Referring back to FIG. 6, for the set of data that is collected for a cycle, an extrapolation module 620 fits a curve to the points of SOC and the corresponding OCV using a predetermined curve fitting algorithm. Example curves fit to the points of the different cycles are illustrated in FIG. 7.

The extrapolation module 620 determines an equation (e.g., polynomial, quadratic, linear, etc.) that characterizes the curve. Using the equation, the extrapolation module 620 determines additional OCVs and determines the corresponding SOCs using extrapolation. The additional OCVs include OCV between the OCVs measured during the execution of the predetermined testing protocol and OCVs that extend to the minimum OCV and maximum OCVs of the LUT 340. The extrapolation module 620 also determines a scaled capacity (fully charged capacity) based on the actual discharge for that cycle using extrapolation. The extrapolation module 620 stores the scaled capacity, the OCVs, and the corresponding SOCs obtained during execution of the predetermined testing protocol during that cycle within the LUT 340. The extrapolation module 620 also stores, in associated with the scaled capacity, the additional OCVs and the corresponding SOCs obtained via extrapolation within the LUT 340. The extrapolation module 620 does this every predetermined number of cycles to generate the LUT 340.

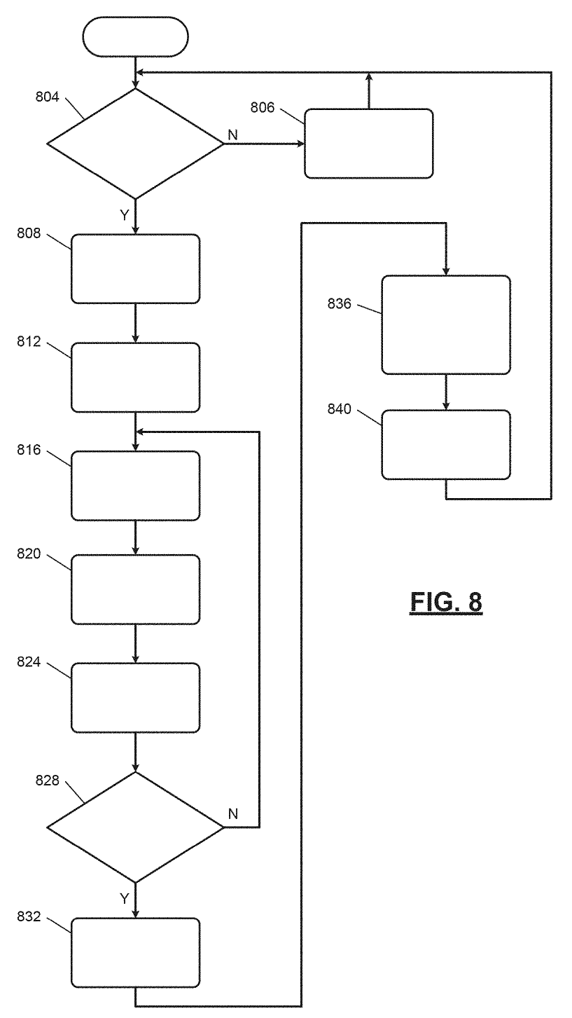

FIG. 8 includes a flowchart depicting an example method of generating the LUT 340 of SOCs indexed by scaled capacities and OCVs. Control begins each predetermined number of cycles, such as every 100 cycles or another suitable number of cycles. For example, control may begin when the cycle count 618 is equal to the predetermined number of cycles, when the cycle count 618 is equal to 2*the predetermined number of cycles, etc. The method follows the DST100 protocol or another suitable protocol. At 804, the testing and storage module 612 may determine whether the battery 608 is fully charged. If 804 is false, the testing and storage module 612 may continue to charge the battery 608 at 806, and control may return to 804. If 804 is true, control may continue with 808.

At 808, the testing and storage module 612 may allow the battery 608 to rest (without charging or discharging) for at least the predetermined period. At 812, the testing and storage module 612 measures the OCV of the battery 608 for the present SOC and stores the OCV and the SOC.

At 816, the testing and storage module 612 discharges the battery 608 such that the SOC decreases by the predetermined amount. At 820, the testing and storage module 612 may allow the battery 608 to rest (without charging or discharging) for at least the predetermined period. At 824, the testing and storage module 612 measures the OCV of the battery 608 for the present SOC and stores the OCV and the SOC.

At 828, the testing and storage module 612 may determine whether the SOC is less than or equal to the predetermined SOC. If 828 is true, control continues with 832. If 828 is false, control may return to 816. The testing and storage module 612 also tracks the capacity consumption of the battery 608 during the discharging, for example, based on the current flow from the battery 608. The testing and storage module 612 determines the total change in capacity (e.g., in Ah) of the battery 608 to discharge the battery 608 from fully charged to having an SOC that is less than or equal to the predetermined SOC.

At 832, the extrapolation module 620 determines the equation fit to the points of OCV and SOC stored at 812 and each instance of 824 using a curve fitting algorithm. At 836, the extrapolation module 620 determines the additional OCVs and the corresponding SOCs using the equation (e.g., by solving the equation for SOC using the corresponding additional OCV). The additional OCVs include OCVs between the points stored and include OCVs that range from the minimum OCV to the maximum OCV. The extrapolation module 620 also determines the scaled capacity based on the total change in capacity at 836.

At 840, the extrapolation module 620 stores the SOCs in association with the OCVs, respectively, and the scaled capacity in the LUT 340. The extrapolation module 620 may also store the cycle count 618 in association with the stored SOCs and OCVs. The cycle module 616 may then increment the cycle count 618. Control may return to 804 to begin again when the predetermined number of cycles have been completed. Once completed, the LUT 340 may be stored to the vehicle by wire or wirelessly via a computing device or the calibration module 604. Wireless communication may be direct or via one or more networks, such as a cellular or satellite network.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A battery system of a vehicle, comprising:
a first storage module configured to selectively store a first open circuit voltage (OCV) of a battery of the vehicle;
a second storage module configured to selectively store a second OCV of the battery of the vehicle;
a discharge module configured to determine a change in capacity of the battery between: (i) the measurement of the first OCV of the battery; and (ii) the measurement of the second OCV of the battery;
a lookup table that is stored in memory and that includes reference states of charge (SOCs) indexed by reference OCVs and reference capacities;
a relationship module configured to:
from the lookup table, identify a first set of the reference SOCs associated with the first OCV and the reference capacities, respectively;
from the lookup table, identify a second set of the reference SOCs associated with the second OCV and the reference capacities, respectively;
determine changes in SOC associated with the reference capacities based on differences between ones of the first set of reference SOCs and ones of the second set of reference SOCs, respectively;
determine changes in capacity based on the changes in SOC and the reference capacities, respectively; and
determine an equation that relates changes in capacity to capacity based on the changes in capacity and the reference capacities, respectively; and
a capacity module configured to determine a present capacity of the battery using the equation and based on the change in capacity of the battery between: (i) the measurement of the first OCV of the battery; and (ii) the measurement of the second OCV of the battery.

2. The battery system of claim 1 wherein the capacity module is configured to solve the equation for capacity given the change in capacity between: (i) the measurement of the first OCV of the battery; and (ii) the measurement of the second OCV of the battery.

3. The battery system of claim 1 wherein the capacity module is configured to set the present capacity based on a weighted sum of the determined present capacity and a previous value of the present capacity and to determine the weights for the weighted sum based on confidence intervals for the determined present capacity and the previous value of the present capacity.

4. The battery system of claim 1 wherein the relationship module is configured to determine the changes in capacity based on mathematical products of the changes in SOC with the reference capacities, respectively.

5. The battery system of claim 1 wherein the OCVs in the lookup table range from a predetermined minimum OCV to a predetermined maximum OCV.

6. The battery system of claim 1 further comprising a state of charge module configured to determine a present SOC of the battery.

7. A system comprising:
the battery system of claim 6;
a display located within a passenger cabin of the vehicle; and
a display module configured to determine a driving range of the vehicle based on the present SOC of the battery and to display the driving range of the vehicle on the display.

8. A system comprising:
the battery system of claim 6;
an engine; and
an engine control module configured to start the engine when the present SOC of the battery is less than a predetermined SOC.

9. The battery system of claim 1 further comprising a voltage sensor configured to measure the first OCV and the second OCV of the battery.

10. The battery system of claim 1 wherein the first storage module is configured to store the first OCV of the battery at vehicle startup when the battery was not charged or discharged for at least a predetermined period before the vehicle startup.

11. The battery system of claim 1 wherein the second storage module is configured to store the second OCV of the battery at vehicle startup after the battery has not been charged or discharged for at least a predetermined period before a vehicle startup.

12. The battery system of claim 1 wherein the discharge module is configured to determine the change in capacity of the battery based on current flow from the battery to an electric motor between: (i) the measurement of the first OCV of the battery; and (ii) the measurement of the second OCV of the battery.

13. A system comprising:
the battery system of claim 1; and
a calibration module that is separate from the vehicle and that is configured to populate the lookup table via execution of a predetermined testing protocol on a second battery.

14. The system of claim 13 wherein the predetermined testing protocol is the Dynamic Stress Test (DST) 100 testing protocol.

15. The battery system of claim 13 wherein the calibration module is configured to:
(i) discharge the second battery such that a present SOC of the second battery decreases by a first predetermined SOC;
after (i), (ii) rest the second battery for a predetermined period;
after (ii), (iii) measure a third OCV of the second battery at the present SOC of the second battery;
repeat (i)-(iii) until the present SOC of the second battery is less than or equal to a second predetermined SOC;
determine a change in capacity of the second battery during discharging of the second battery from an initial SOC to less than or equal to the second predetermined SOC; and
determine a capacity of the second battery based on the change in capacity; and
index the present SOCs in the lookup table by the third OCVs and the capacity of the second battery.

16. The battery system of claim 15 wherein the calibration module is further configured to:
determine first additional reference OCVs that are less than a minimum one of the third OCVs;
determine second additional reference OCVs that are greater than a maximum one of the third OCVs;
determine third additional reference OCVs that are between ones of the third OCVs;
based on the present SOCs and the third OCVs:
determine first additional reference SOCs corresponding to the first additional reference OCVs, respectively;
determine second additional reference SOCs corresponding to the second additional reference OCVs, respectively; and
determine third additional reference SOCs corresponding to the third additional reference OCVs, respectively; and
index the first, second, and third additional reference SOCs in the lookup table by the first, second, and third additional reference OCVs, respectively, and the capacity of the second battery.

17. A method, comprising:
selectively storing a first open circuit voltage (OCV) of a battery of a vehicle;
selectively storing a second OCV of the battery of the vehicle;
a determining a change in capacity of the battery between: (i) the measurement of the first OCV of the battery; and (ii) the measurement of the second OCV of the battery;
from a lookup table including reference states of charge (SOCs) indexed by reference OCVs and reference capacities, identifying a first set of the reference SOCs associated with the first OCV and the reference capacities, respectively;
from the lookup table, identifying a second set of the reference SOCs associated with the second OCV and the reference capacities, respectively;
determining changes in SOC associated with the reference capacities based on differences between ones of the first set of reference SOCs and ones of the second set of reference SOCs, respectively;
determining changes in capacity based on the changes in SOC and the reference capacities, respectively;
determining an equation that relates changes in capacity to capacity based on the changes in capacity and the reference capacities, respectively; and
determining a present capacity of the battery using the equation and based on the change in capacity of the battery between: (i) the measurement of the first OCV of the battery; and (ii) the measurement of the second OCV of the battery.

18. The method of claim 17 further comprising solving the equation for capacity given the change in capacity between: (i) the measurement of the first OCV of the battery; and (ii) the measurement of the second OCV of the battery.

19. The method of claim 17 further comprising setting present capacity based on a weighted sum of the determined present capacity and a previous value of the present capacity and to determine the weights for the weighted sum based on confidence intervals for the determined present capacity and the previous value of the present capacity.

20. The method of claim 17 further comprising determining the changes in capacity based on mathematical products of the changes in SOC with the reference capacities, respectively.
